(19) United States
(12) Patent Application Publication
(10) Pub. No.: US 2005/0235249 A1
(43) Pub. Date: Oct. 20, 2005

(54) Method and system for monitoring status and performance of an enterprise facility

(76) Inventors: Armin L. Friemelt, Offenburg (DE); Mark Thomas Schuette, Ilvesheim (DE); Stefan W. Elfner, Heidelberg (DE); Norbert Broeker, Rauenberg (DE); Gabriele D. Lahme, Mannheim (DE); Jutta Wesemann-Ruzicka, Mannheim (DE); Juergen Wettengl, Wettenberg (DE)

Correspondence Address: KENYON & KENYON, 1500 K STREET NW, SUITE 700, WASHINGTON, DC, 20005, US

(21) Appl. No.: 11/065,051

(22) Filed: Feb. 25, 2005

Related U.S. Application Data
(60) Provisional application No. 60/562,223, filed on Apr. 15, 2004.

(51) Int. Cl. G06F 9/44

(52) U.S. Cl. 717/102

(57) ABSTRACT

Embodiments of the present invention relate to a method and system for integrating and displaying information about one or more enterprise facilities. Descriptors representing information about the status and performance of a facility or multiple facilities may be collected and presented in a single computer screen display along with associated values, enabling a manager to see the status of the facility or facilities at a glance and consequently to be able to make better plans and decisions. The embodiments may further provide a number of interactive features, including enabling users to create customized views and customized status thresholds.

### BACKGROUND OF THE INVENTION

Automated systems for collecting and displaying information about an enterprise facility (also, “plant”) are known. The systems gather information relating to such performance measures as machine uptime/downtime, enterprise output, worker availability and the like. The information may be reviewed and analyzed by persons (herein called “managers”) with responsibility for controlling, monitoring and supervising operations in the enterprise facility. For example, the information may let managers determine such things as whether enterprise schedules are being met, whether machine repairs are needed, and so on.

However, known status monitoring systems are not well-integrated. For example, to obtain information needed for planning, a manager might have to log on to several different computer systems, each monitoring a respective station. Such fragmentation in the information needed by the manager can make it difficult to get an accurate picture of the status and performance of an enterprise facility, and consequently to see ahead to potential problems and make good decisions. Further, known systems are limited in terms of their ability to be customized according to user preferences.

### BRIEF DESCRIPTION OF THE DRAWINGS

FIGS. 1 and 2 show hardware platforms suitable for implementing embodiments of the present invention; and

FIG. 3-9, 9A-9C, and 10-14 show examples of displays of a user interface according to embodiments of the present invention.

### DETAILED DESCRIPTION

Embodiments of the present invention relate to a method and system for integrating and displaying information about one or more enterprise facilities. More specifically, embodiments of the present invention relate to computer-executable instructions to generate a user interface to interactively display information about an enterprise facility, and to perform operations in response to user inputs entered via the interface. According to the embodiments, descriptors representing information about the status and performance of a facility or multiple facilities may be collected and unified for presentation in a single computer screen display along with associated values, enabling a manager to see the status of the facility or facilities at a glance and consequently to be able to make better plans and decisions. The embodiments may further provide a number of interactive features. Among others described in more detail below, the interactive features may include enabling users to create customized views that let the users filter out information that they are not interested in and only view descriptors of interest. The interactive features may further include enabling the customization of status thresholds relating to the descriptors.

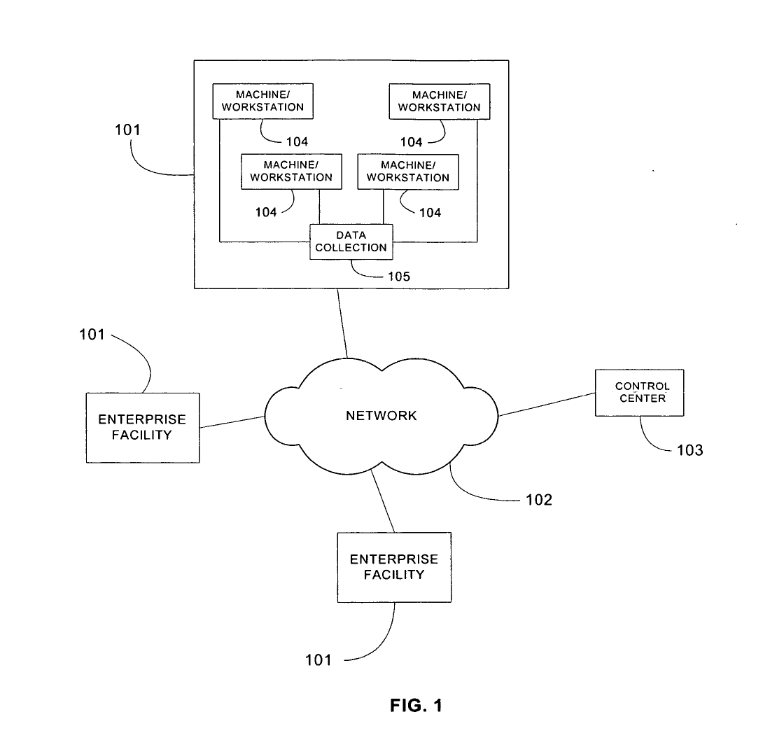

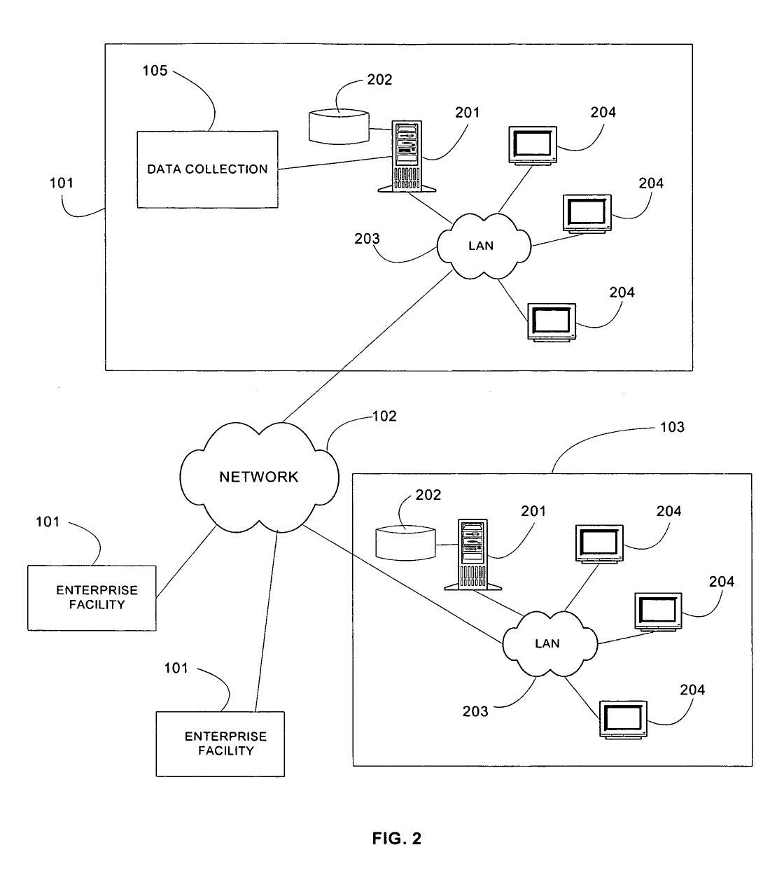

FIGS. 1 and 2 illustrate an environment wherein embodiments of the present invention might find useful application. As shown in FIG. 1, a plurality of different enterprise facilities 101 in respective different geographical locations may be connected to an external network 102. The enterprise facility 101 uppermost in FIG. 1 is shown in more detail than the others. An enterprise facility 101 may include machines/workstations 104 e.g. for the production of goods. Data collection equipment 105 may collect information about the machine/workstations 104. For example, the machines/workstations 104 may be electronically coupled to data collection equipment 105 and provide electronic signals to the data collection equipment 105. Based on the signals, the data collection equipment 105 may collect data reflecting a performance, condition or other aspect of a machine/workstation, such as how many hours the machine/workstation has been in operation, how many items it has produced, how many malfunctions it has experienced, or the like. Additionally or alternatively, human operators may gather data concerning the machines/workstations, or other information that could be pertinent to a performance, efficiency, status or the like of an enterprise facility, and provide it to the data collection equipment 105 or to a computerized information storage and retrieval system associated with or supplemental to the data collection equipment 105. A control center 103 not necessarily including machines/workstations may also be coupled to the network 102, and receive and process data collected by the data collection equipment or supplemental information storage and retrieval system.

Referring now to FIG. 2, an enterprise facility 101 may further comprise a computer 201 comprising a processor and memory, and a database 202 comprising data electronically stored on a machine-readable medium such as disk. The data collection equipment 105 may be coupled to the computer 201 and provide the data it collects to the computer 201. The computer 201 may store the data on the database 202. The enterprise facility 101 may further comprise a local area network (LAN) 203 that could be served by the computer 201. Users of the network 203 may log on to the network via terminal devices 204. The terminal devices 204 may include display monitors capable of graphically displaying information and receiving user input, and input devices such as a keyboard and/or mouse to enter the user input.

For example, using a terminal device such as a device 204, a user may log on to the LAN 203 and invoke software according to embodiments of the present invention. The software may comprise computer-executable instructions to generate a user interface to interactively display information about the enterprise facility 101, based on the data collected and stored in the database 202. The software could be, for example, also stored on the database 202 or on another machine-readable medium coupled to the computer 201, and be retrieved and executed by the computer 201 when invoked. Via the user interface, the user could view information about the status, condition, performance or the like of the enterprise facility 101, and enter inputs to cause the user interface to perform certain operations as described in more detail hereafter.

The user may view information about enterprise facilities 101 in other geographical locations. As discussed with reference to FIG. 1, a plurality of enterprise facilities 101 may be connected to an external network 102 and be able to exchange data with each other via the external network 102. A control center 103 not necessarily directly involved in the production of goods may also exchange data with the enterprise facilities via the external network 102. The control center 103 may also comprise a computer 201, a database, a LAN 203 and terminal devices 204.

There could be a system in place for controlling access to the information available via the user interface according to embodiments of the present invention. The system could include the use of personal identifiers and associated passwords for logging on to the LAN 203 and external network 102. Access to information could be controlled based on the personal identifiers and associated passwords (hereafter, “logons”). For example, there could be a general level of access to basic information available to any logon, while access to other, more sensitive information might require a level of authorization higher than that generally held. A manager's logon, for example, could have access to more information than would a logon of a worker on the “shop floor.”

In a feature that is related to access but has less to do with authorization as such, presentation of information may be “personalized” with customized settings put in place by an individual user. Such personalized presentation, for example, could be based on an individual user's manipulation of the user interface to create “views” in accordance with his/her preference. The user's preferences could be recorded in his/her network profile, for example, and only be active for someone logging on with that user's logon.

Operations according to embodiments of the present invention are described and illustrated in the following by way of an extended example. Assume there is a company with two production facilities, one in Chicago, Ill. and one in Oswego, Ill. A production plan is in place that calls for machines of each production site to be used at 80% capacity. Further assume that software according to embodiments of the present invention is installed at each of the production facilities on a suitable hardware platform, for example one as described with reference to FIGS. 1 and 2. Assume a user logs on to a terminal device 204 and invokes software according to embodiments of the present invention.

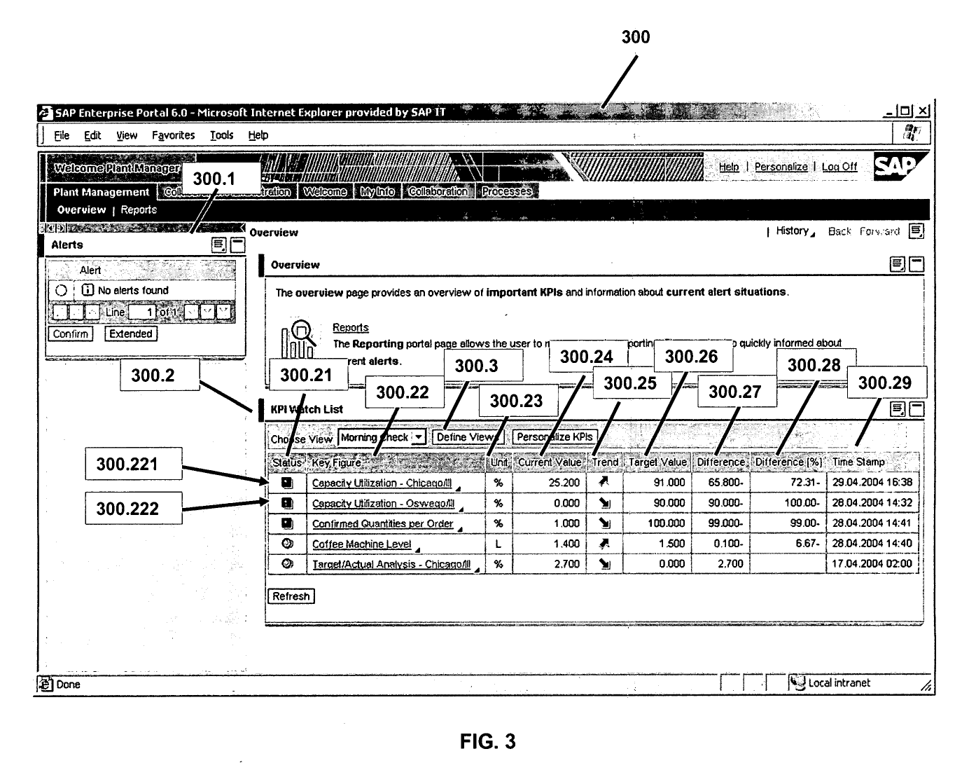

FIG. 3 shows a screen display 300 that a user interface of the software may present. The display 300 includes fields for information output and fields capable of receiving user input and causing operations to be performed in response thereto. One field is an Alerts field 300.1. The Alerts field 300.1 may display one or more alerts based on personalized settings as described in more detail hereafter. In the example of FIG. 3, no alerts are being displayed.

The display 300 may include a “KPI Watch List” field 300.2 (KPI stands for “Key Performance Indicator”). The KPI Watch List field 300.2 includes a list of descriptors of one or more enterprise facilities. In this disclosure, the descriptors may also be referred to as “key figures.” Each of the key figures in the KPI Watch List may describe something about a enterprise facility, such as its level of productivity, its efficiency, worker availability in the facility, machine uptime/downtime, or the like. The key figures may be stored in a persistent key figure buffer that is updated periodically in the background and is able to offer the aggregated information within a very short time without recomputing the information again and again.

Each entry in the KPI Watch List field 300.2 may comprise a status field 300.21, an identifier field 300.22, a unit field 300.23, a current value field 300.24, a trend field 300.25, a target value field 300.26, a difference field 300.27, a difference [%] 300.28 (i.e., a difference expressed in terms of percentage), and a time stamp field 300.29.

The identifier field 300.22 may identify, by a short, descriptive label or phrase, a key figure whose status, current value, etc. is being presented in a given entry. For example, the key figure of entry 300.221 has the identifier “Capacity Utilization—Chicago/Ill.” and the key figure of entry 300.222 has the identifier “Capacity Utilization—Oswego/Ill.” Accordingly, these key figures may describe to what extent capacity is being utilized at the Chicago and Oswego production sites, respectively.

A respective status field 300.21 for each entry may indicate a status of the associated key figure based on predetermined criteria for the key figure. For example, a key figure could have a “green” or normal status to indicate that the key figure is within a normal or expected range of values, a “yellow” status indicating that the key figure is outside the normal or expected range of values, and a “red” status to indicate that attention is urgently required to whatever condition is represented by the key figure. Whether the key figure has a green, yellow, red or other status may be controlled by an adjustable threshold setting described in more detail further on. In the example of FIG. 3, the status fields are red for both of the Capacity Utilization key figures. The red status could indicate that the key figures are outside an expected range. For example, as noted above, the production plan for the Chicago and Oswego sites calls for 80% capacity utilization. Because, as shown in the current value field 300.24 for entry 300.221, the current value of the Capacity Utilization key figure for the Chicago site is 42.100 while the target value 300.26 is 91.000, the capacity utilization of the Chicago site is well below 80%. This is further evident in the difference field 300.28, which shows that capacity utilization is below a target value by 53.74%. The situation is similar for the Capacity Utilization key figure for the Oswego site.

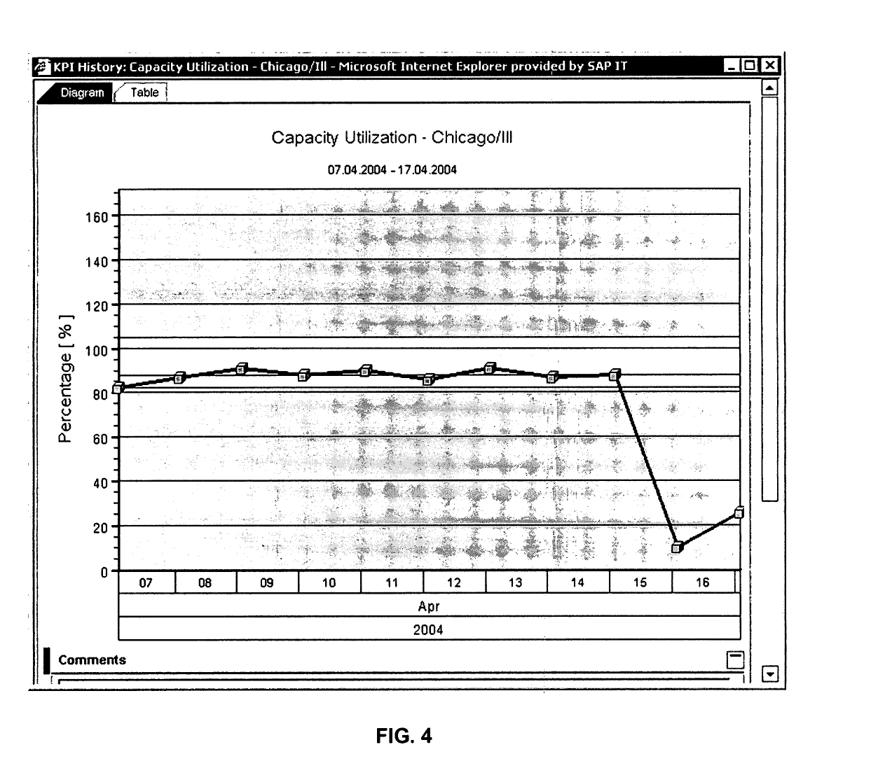

The trend field 300.25 may, in a passive mode, display a trend (upward, downward or unchanged) of a corresponding key figure value over a period of time. The trend field 300.25 may further, in an active mode, provide for receiving user input and, upon receiving user input, performing certain operations. For example, by clicking on the trend field 300.25 with an input device such as a mouse, a user could invoke operations to cause a more detailed display of a trend of a key figure value to be generated on the user interface. FIG. 4 shows an example of the latter. That is, FIG. 4 shows an example of a screen display that might be generated by a user clicking on the trend field 300.25 of the entry 300.221 corresponding to the Chicago site.

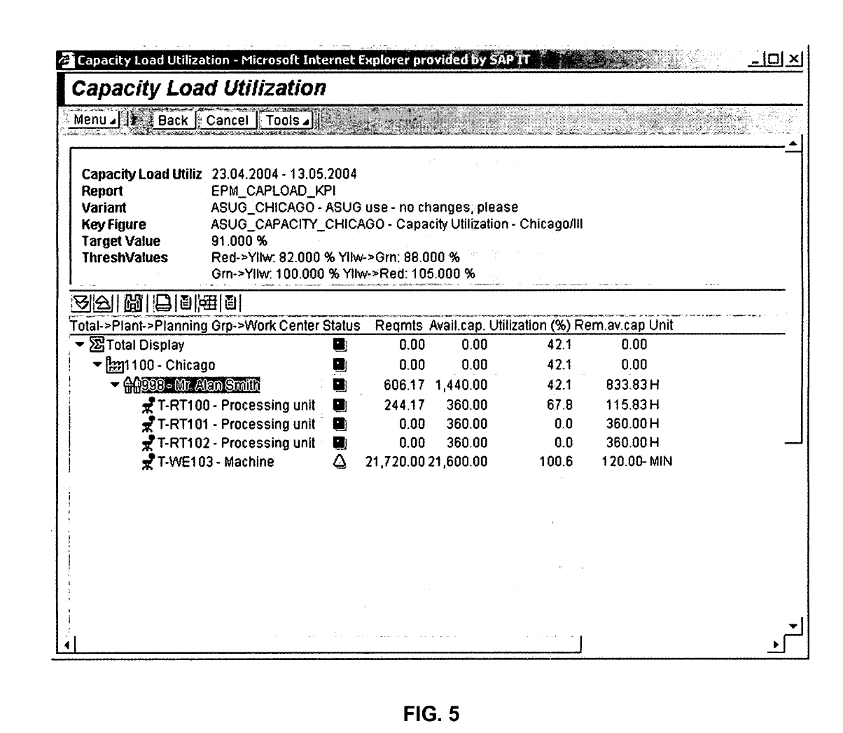

The identifier field 300.22 may also have an active mode responsive to user input. For example, in response to a user clicking on the identifier field 300.22, operations may be performed to generate detailed information about the site to which the corresponding key figure relates. FIG. 5 shows an example of a screen display that might be generated by a user clicking on the identifier field 300.22 of the entry 300.221 corresponding to the Chicago site. The display might include information about an enterprise facility with a level of detail that allows for troubleshooting. For example, the information might make it possible to pinpoint a failing workstation and contact the person in charge of the workstation for an explanation or to send help.

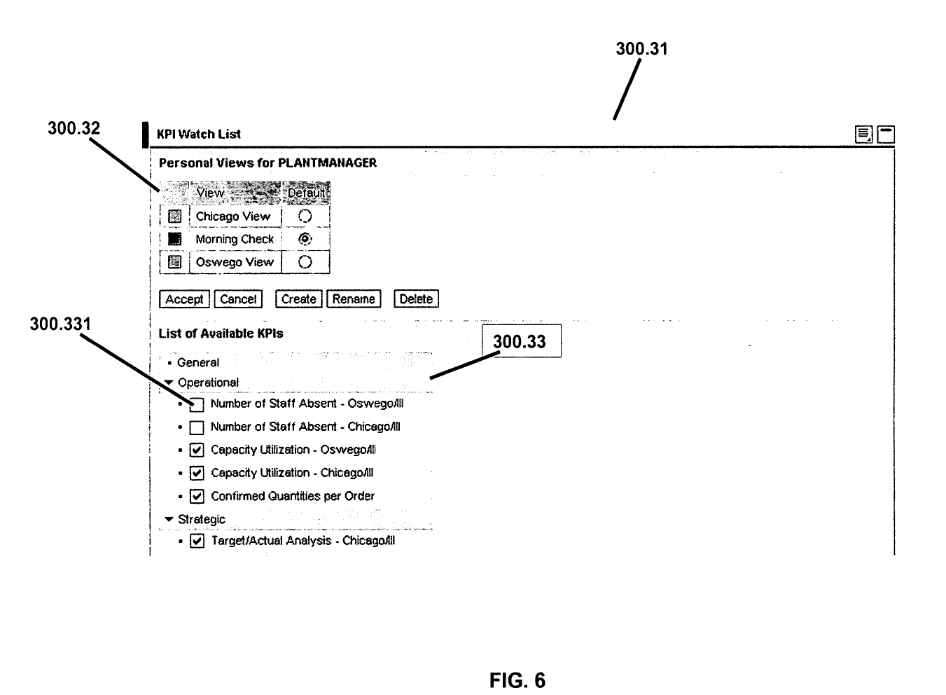

Embodiments of the present invention further provide for the customization of views of key figures. Referring now to FIG. 3, a screen display according to embodiments of the present invention may further include a “Define Views” field 300.3. By clicking on the Define Views field, operations may be invoked to generate a screen display to enable the modification of the list of key figures displayed in the KPI Watch List field 300.2. FIG. 6 shows an example of such a screen display 300.31. The display may include a list of currently available views 300.32. Any of the views may be made active by selecting and clicking on its label in the list 300.32. In the example presently under discussion, a “Morning Check” view is the active view and corresponds to the key figures discussed earlier with reference to FIG. 3. Other views which could be selected include a “Chicago View” and an “Oswego View.” Each of these views might include a set of key figures different from the key figures of the Morning Check view. For example, the Chicago View might include a set of key figures more pertinent to the Chicago production site in particular, while the Oswego View might include a set of key figures more pertinent to the Oswego site in particular.

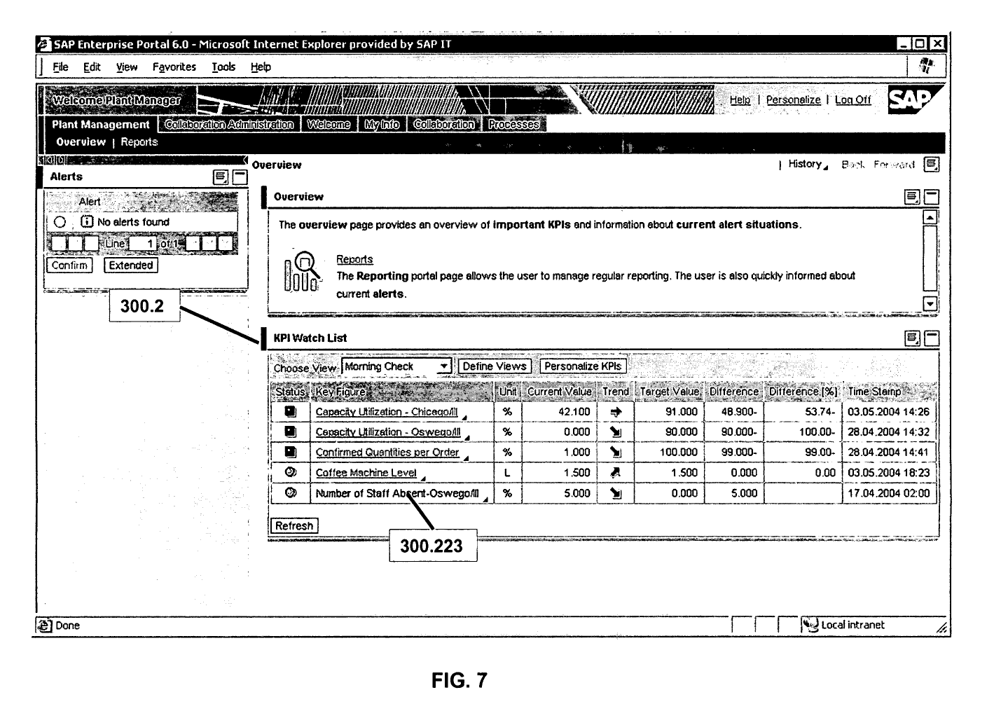

The display 300.31 for selection and modification of a key figure view may further include a list of available key FIGS. 300.33 that may be added to a given view. For example, it may be decided by management that it would be useful in planning to know at a glance the number of staff absent from a given enterprise facility. Accordingly, a key figure “Number of Staff Absent” might be created per enterprise site. The corresponding data would be collected and made available in the database 202 (see FIG. 2), and the option of including the key figure in a particular view, as shown in field 300.33. would be made available. To include the key figure, a user might click on a corresponding “check box” 300.331 and then click on “Accept.” As shown in FIG. 7, the new key FIG. 300.223 may then appear in the KPI Watch List field 300.2.

Referring again to FIG. 6, a user may also be provided with the options to “Cancel” an operation, to “Create” a new view, to “Rename” a view, or to “Delete” a view.

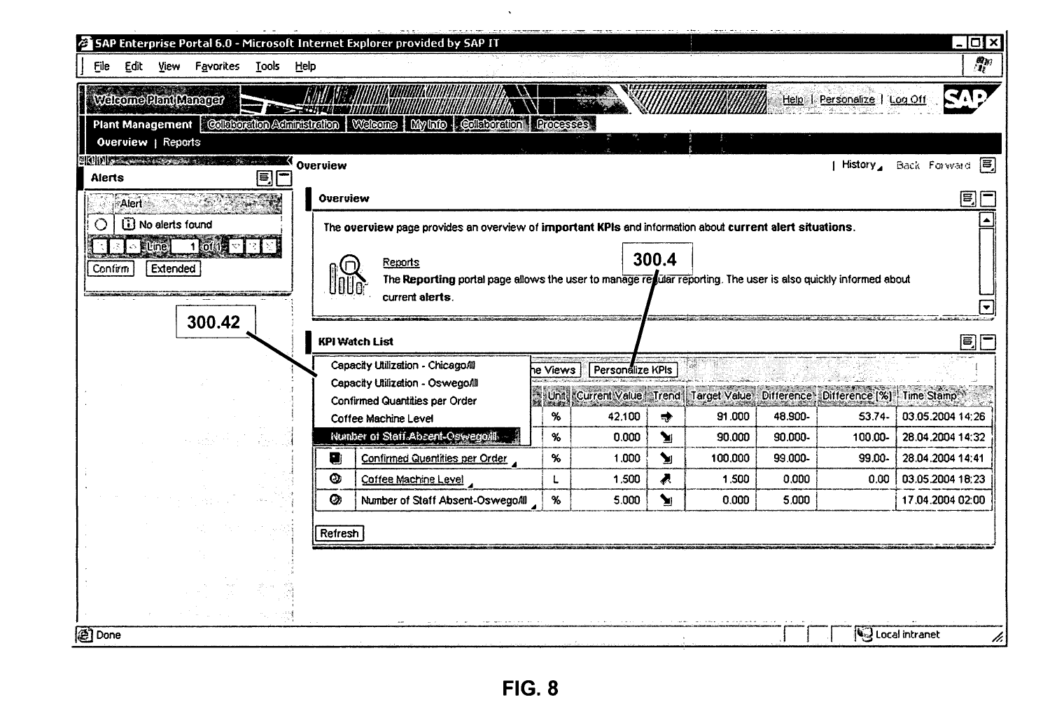

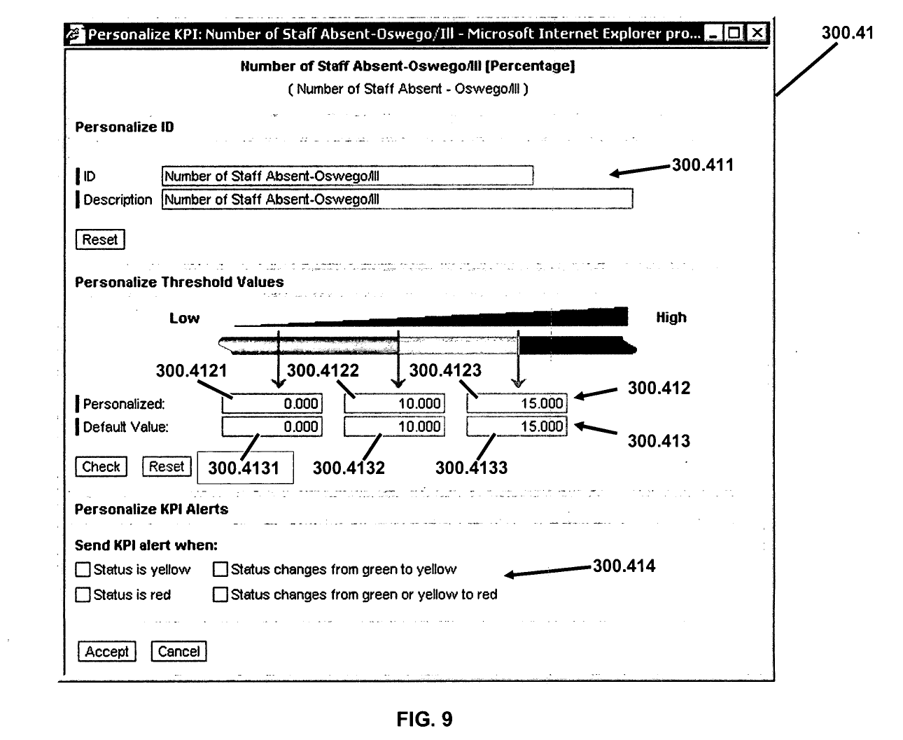

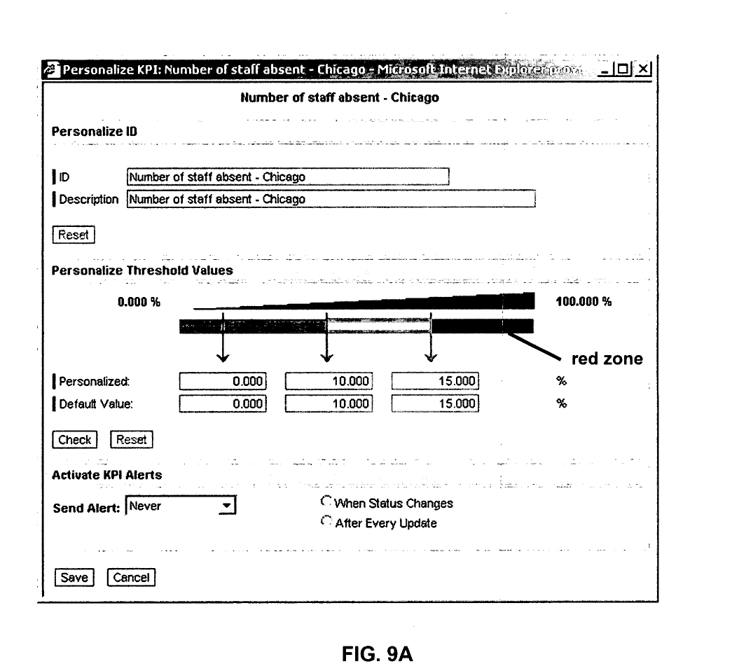

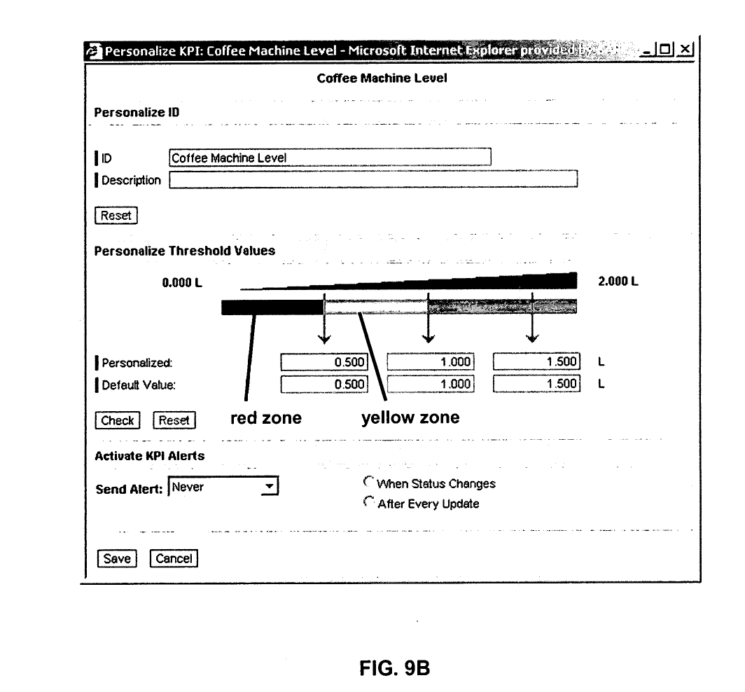

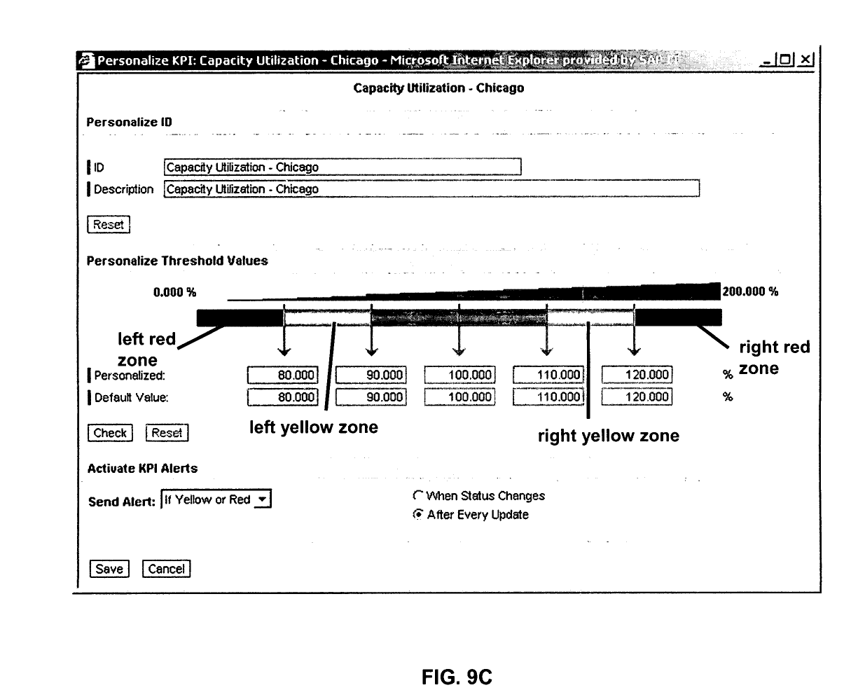

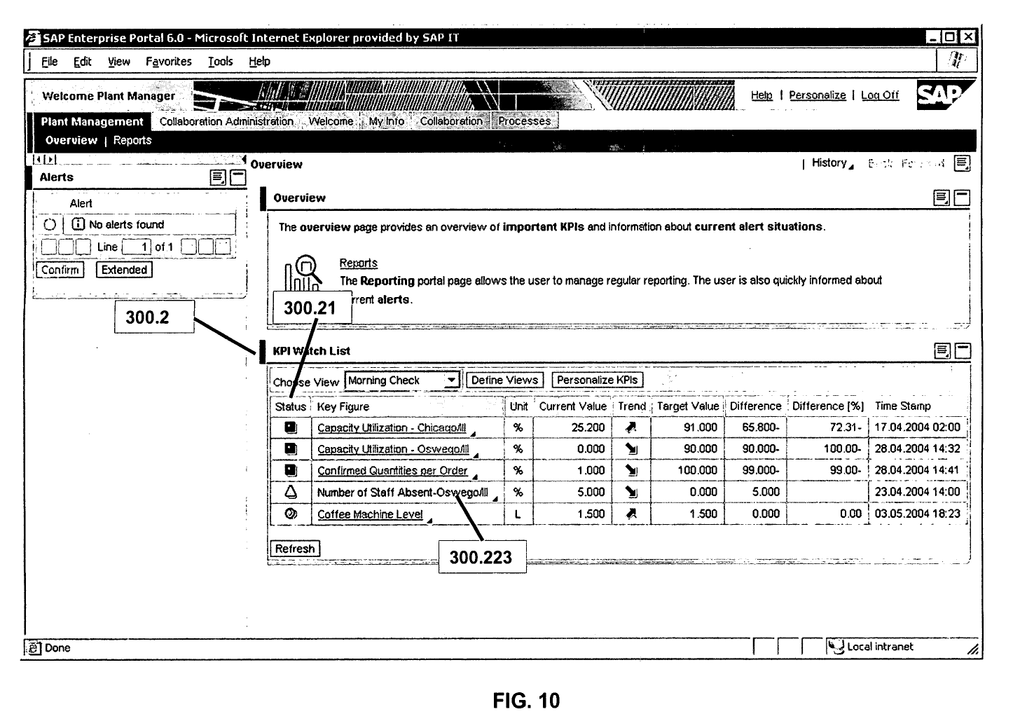

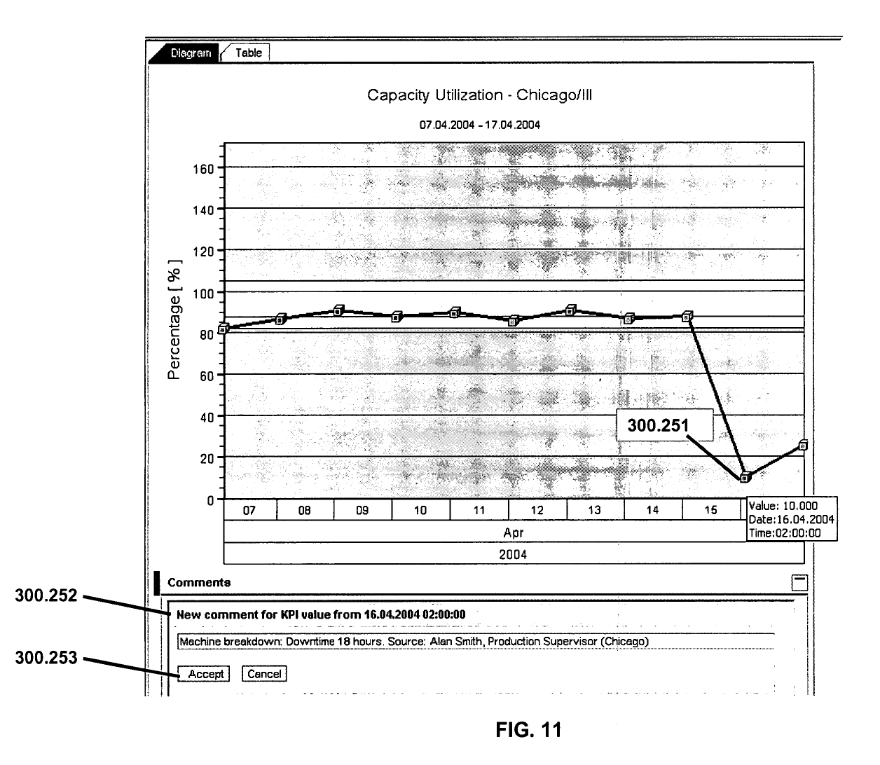

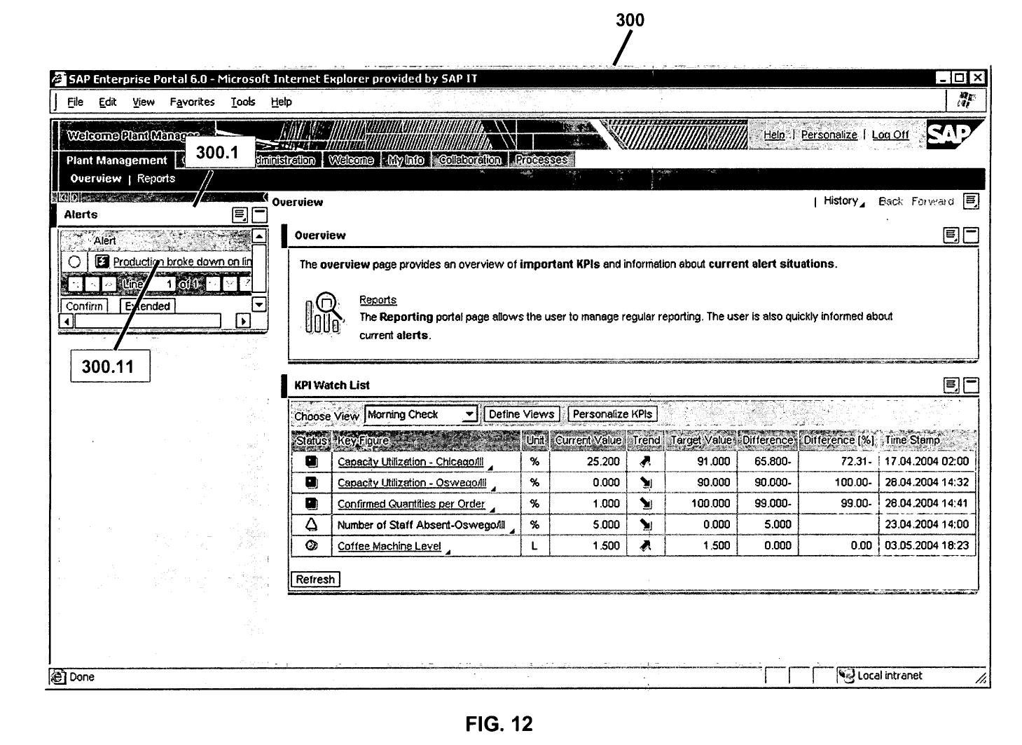

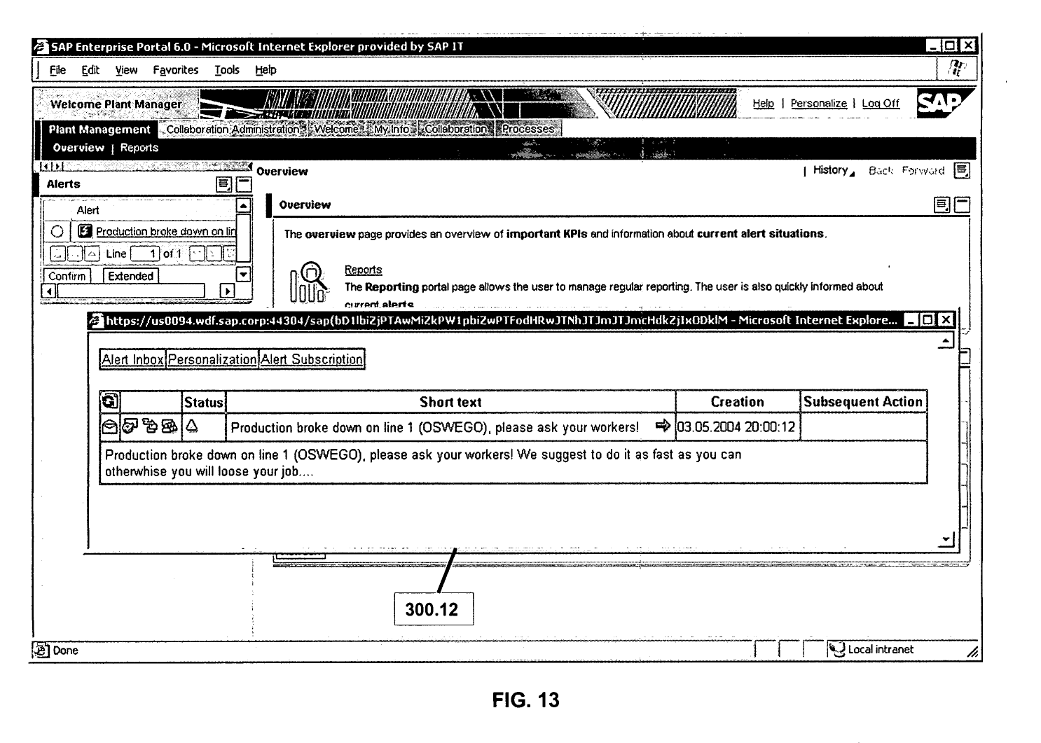

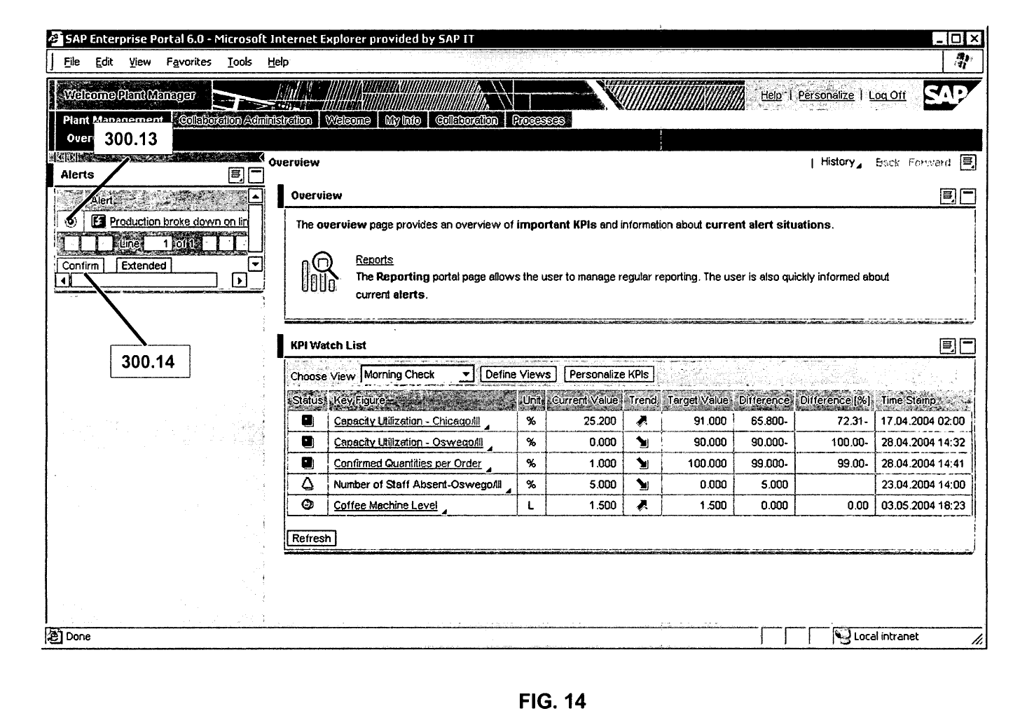

Embodiments of the present invention may further provide for changing status thresholds. Referring now to FIG. 8, the KPI Watch List field may further include a “Personalize KPIs” field 300.4 for setting or modifying thresholds relating to key figures. By clicking on the Personalize KPIs field 300.4, operations may be invoked to cause a pop-up window 300.42 to appear for the selection of a key figure. Assume the key figure “Number of Staff Absent—Oswego/Ill.” is selected. The selection may further cause operations to be performed to generate a screen display to enable the setting or modification of thresholds relating to the selected key figure. FIG. 9 shows an example of such a screen display 300.41. The screen display 300.411 may include fields for a key figure identifier and description 300.411 and fields for setting threshold values associated with the key figure. The latter may include a set of “Personalized” fields 300.412 and a “Default Value” set of fields 300.413.

Ranges defined by the threshold values may respectively correspond to a “green” status, a “yellow” status or a “red” status as displayed in the status field 300.21 of the KPI Watch List field 300.2 (see FIG. 3). For example, the values in fields 300.4131 and 300.4132 of the Default set 300.413 may mean “when the number of staff absent is between 0 and 10, display a green status for the key figure.” The values in fields 300.4132 and 300.4133 of the Default set may mean “when the number of staff absent is between 10 and 15, display a yellow status for the key figure.” Finally, the value in field 300.4133 may mean “when the number of staff absent is over 15, display a red status for the key figure.”

The Default values may determine what is generally seen as the status for key figures, for example within an enterprise facility as a whole or for an enterprise facility in a different geographical location, while a given user can set the Personalized values according to his/her own preferences. Default values could be set for any given descriptor or key figure, and may determine what any user logging on to the LAN 203 or WAN 102 would see in displays of the user interface in the absence of any personalized threshold values. Access to the Default values to change them could require a certain authorization level not available to all users (for example, that of a network administrator), so that any user could not arbitrarily change the general presentation of the user interface. The Personalized values, on the other hand, could be stored in, for example, an individual user's network profile and only be accessible to someone logging on with that user's logon.

Thus, an individual user who logs on to a LAN 203 using his/her personal logon may set values in the Personalized value set 300.412 according to his/her preferences, and the values may stored in the user's network profile. The user might, for example, want to set thresholds for a particular key figure to be lower for the triggering of a status change from green to yellow, or yellow to red, because he/she is individually responsible for a process or thing, e.g. a work station, whose performance is reflected in the particular key figure. In the present example, where the thresholds for the key figure “Number of Staff Absent—Oswego/Ill.” are being changed, the user may be a person responsible for staffing a facility, who wants an early alert if staffing shortfalls appear likely.

Referring now again to FIG. 9, assume a user sets values in fields 300.4121, 300.4122 and 300.4123 of the Personalized set 300.412 to 0, 3 and 8, respectively. Because these values are lower than the values of the Default set, the corresponding status display may change in the KPI Watch List field 300.2, as shown in FIG. 10. As shown in FIG. 10, the display in the status field 300.21 for the key FIG. 300.223 has changed from green to yellow (as compared with FIG. 8) because the range for yellow under the personalized view is 3 to 8 and the current value is 5.

Key figures may more specifically include three types: (1) negative key figures, meaning that high values for the key figures are unfavorable; (2) positive key figures, meaning that high values for the key figures are favorable; and (3) bi-directional key figures, meaning that the key figures have a target range and deviation beyond the range, either above or below, is unfavorable. An example of a negative key figure is the number of sick days for an employee in a specific period of time. An example of a positive key figure is company profits. An example of a bidirectional key figure is the temperature range for storing a material—either too high or too low is bad for the material. For negative key figures, it may be possible to set personal threshold values lower, but not higher, than a default value. For positive key figures, it may be possible to set personal threshold values higher, but not but lower, than a default value. For bidirectional key figures, it may be possible to set personal upper and lower threshold values between upper and lower default values, but not outside the upper and lower default values.

FIG. 9A shows an example of a screen display corresponding to a negative key figure, “Number of staff absent” (ideally all staff are present when scheduled). In the example of FIG. 9A, assume that a company-wide default threshold for a red status for this key figure is 15. Suppose that in order to react in time the manager in plant X wants to be informed a bit earlier about absent staff (e.g. before his boss is informed). The manager may set his personal threshold at a lower value than the default, which has the effect of extending his “red zone” to the left. For example, the manager might personalize the “Number of staff absent” key figure value to 10, meaning that his personal “Number of staff absent” key figure drops into the red zone as soon as 11 employees are absent. This could allow the manager to acquire some additional staff before his boss became alarmed. On the other hand, the manager may not be permitted by the software to set his personal threshold values to values above the company default (i.e. higher than 15 for the yellow-to-red transition).

FIG. 9B shows an example of a screen display corresponding to a positive key figure, “Coffee machine level”. Here, the user is able to personalize his threshold values higher than a default value, with the effect that the red or yellow zones are extended to the right. Thus, the yellow zone could start at, for example, 0.8 L, and the green zone could start at, for example, 1.2 L. On the other hand, the user may not be permitted by the software to set his personal threshold values to values below a default value.

FIG. 9C shows an example of a screen display corresponding to a bi-directional key figure. Here, the user may extend the left red and the left yellow zones to higher values as well as extend the right yellow and red zones to lower values. Bi-directional key figures may be understood as a combination of both positive and negative key figures (the left part resembles a positive key figure and the right part resembles a negative key figure).

Returning to FIG. 9, the display 300.41 may further provide for letting a user specify when he/she wants to receive an alert based on a key figure status. Such alerts may be displayed in the Alerts field 300.1 (see FIG. 3 and earlier discussion) or may be sent to a recipient by other means (e.g. email, pager, fax machine, etc.). As shown in FIG. 9, options 300.414 selectable by a user as conditions for triggering an alert may include specific definitions of the KPI status and/or a status change of the KPI, or other situations related to KPI status (e.g. whether the status has changed for the first time or whether it has changed repeatedly). By selecting one or more of these options, a user may set values indicating when he/she wants an alert to be generated and appear in the Alerts field 300.1.

Embodiments of the present invention may further provide for adding free-form text to a key figure value. To use this feature, a user may click on the trend field 300.25 (see FIG. 3). In response, a display as shown in FIG. 11 may be presented. By clicking on a symbol 300.251 representing a stored or historical key figure value (in this example, the key figure is “Capacity Utilization—Chicago/Ill.”), a text entry box 300.252 may appear. A user may enter any text desired, then click the “Accept” button 300.253 to relate the text to the key figure and store the text. The text will thereafter be available to any user authorized to access information relating to the key figure concerned.

FIG. 12 shows an example of the display 300 of the user interface according to embodiments of the present invention where an alert 300.11 is displayed in the Alerts field 300.1. An alert may be generated based on key figure values. The alert may appear in the Alerts field 300.1.

Key figure values may be periodically updated. After each update, it may be determined for each user having an updated key figure in his views, based on his personalized thresholds and the default thresholds, whether an alert should be generated. The alert could be based on a key figure reaching or exceeding a threshold value.

For example, suppose user 1 adds a negative key figure, KF1, to one of his views, and specifies that an alert should be generated when the KF1 status is red (see FIG. 9). Further, user 1 personalizes his yellow-to-red transition threshold to 40%. Suppose user 2 does the same as user 1 but keeps the default yellow-to-red transition threshold of 50%. Then, suppose on the next update of KF1, it takes on the value of 45%. User 1 would receive an alert but user 2 would not.

FIGS. 12 and 13 illustrate a general alert based on an alert category definition. When a user clicks the alert 300.11 to see what it is about, an expanded display window 300.12 may be generated as shown in FIG. 13. The expanded display window 300.12 includes text that is part of the alert category definition. Here, the alert category definition is the breakdown of a production line. The definition of an alert category may include a short description (300.11), a short text (see header “Short text”, window 300.12), and a long text (see “Production broke down on line 1 . . . otherwise you will lose your job”, window 300.12). Alerts or portions thereof could also be automatically emailed, faxed, or sent to a mobile communication device such as a cell phone, PDA (personal digital assistant) or pager. For example, the short text portion of an alert could be sent to a pager, while the long text portion could be emailed or faxed. It is also possible to include data containers (i.e., variables) that are filled during the alert creation in order to add parameters to the alert message.

As discussed earlier, embodiments of the present invention may comprise computer-executable instructions stored on a machine-readable medium. The computer-executable instructions may be stored and transported on machine-readable media such as diskette, CD-ROM, and magnetic tape. The computer instructions may be retrieved from the machine-readable media using suitable reading devices into a memory coupled to a processor, and executed by the processor. The computer-executable instructions may be distributed across a plurality of media, such as on physically separate storage devices respectively associated with physically separate computer systems that may communicate via a network. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method comprising:
receiving information from each of a plurality of enterprise facilities; and
integrating the information into a unified presentation via an interactive user interface;
wherein the information comprises at least a first descriptor corresponding to a first enterprise facility, and a second descriptor corresponding to a second enterprise facility, each of the first and second descriptors quantifying an aspect of a performance of the corresponding enterprise facility; and
wherein the user interface is customizable to set a personalized threshold value according to an individual user's preference, the personalized threshold value determining a status of a descriptor, and the personalized threshold value being modifiable independently of a general threshold value that determines the status for a general audience.

2. The method of claim 1, wherein the user interface is customizable to create views of selected descriptors of the enterprise facilities.

3. A system comprising:
a plurality of nodes coupled to a network, wherein at least two of the nodes are enterprise facilities capable of transmitting information via the network;
wherein at least one of the nodes integrates information descriptive of each of the plurality of enterprise facilities received via the network, and interactively presents the information in a user interface; and
wherein the user interface is customizable to set a personalized threshold value according to an individual user's preference, the personalized threshold value determining a status of a descriptor, and the personalized threshold value being modifiable independently of a general threshold value that determines the status for a general audience.

4. The system of claim 3, wherein the user interface is customizable to present selected descriptors of the enterprise facilities.

5. A method comprising:
generating a user interface to interactively display information about an enterprise facility, the information including at least one descriptor of the enterprise facility; and
performing operations in response to user inputs entered via the interface, the operations including modifying a personalized threshold value according to an individual user's preference, wherein the personalized threshold value determines a status of the descriptor, the personalized threshold value being modifiable independently of a general threshold value that determines the status for a-general audience.

6. The method of claim 5, wherein the descriptor relates to an aspect of a performance of the enterprise facility.

7. The method of claim 6, wherein the descriptor quantifies the performance.

8. The method of claim 7, further comprising displaying trend information about the descriptor.

9. The method of claim 5, further comprising:
presenting a first list of descriptors of the enterprise facility in a display;
modifying the first list based on user input to add a new descriptor to the first list to form a second list; and
presenting the second list in a display.

10. The method of claim 5, further comprising:
presenting a list of descriptors of the enterprise facility in a first display, each descriptor of the list of descriptors having associated therewith a set of values;
in response to user input, presenting a second display including information about a descriptor in the list that is supplemental to the set of values associated with that descriptor.

11. The method of claim 5, wherein a first status indicates that the descriptor has a value that is within a predetermined range, and a second status indicates that the descriptor has a value that is outside the predetermined range.

12. The method of claim 11, wherein the personalized threshold value is modifiable to adjust the predetermined range, such that the first status changes to the second status or vice versa based on different criteria from criteria that determine the first status and second status for the general audience.

13. The method of claim 5, further comprising generating an alert based on a status of the descriptor.

14. A machine-readable medium storing program instructions that, when executed by a computer, cause the computer to perform the method of claim 1.

15. A machine-readable medium storing program instructions that, when executed by a computer, cause the computer to perform the method of claim 5.
